(19) United States
(12) Patent Application Publication
(10) Pub. No.: US 2006/0212303 A1
(43) Pub. Date: Sep. 21, 2006

(54) System and method for litigation risk management

(75) Inventors: Charles James, Danville, CA (US); Mark Allen Cervenka, San Ramon, CA (US)

Correspondence Address: CHEVRON TEXACO CORPORATION, P.O. BOX 6006, SAN RAMON, CA, 94583-0806, US

(73) Assignee: Chevron U.S.A. Inc.

(21) Appl. No.: 11/086,483

(22) Filed: Mar. 21, 2005

(51) Int. Cl. G06Q 99/00

(52) U.S. Cl. 705/1

(57) ABSTRACT

A method for corporate litigation risk management for managing claims and legal actions including: forming a team including a managing attorney, a business owner, and an outside counsel for managing the claim or legal action, where the team forming step occurs within three days of notice of the claim or legal action; preserving documents, witnesses, and recollections related to the claim, where the preserving step occurs within ten days of notice of the claim or legal action, and where attorney-client privilege is established for all communications during the preserving step; evaluating the claim with a litigation risk analysis, where the evaluating step occurs within 90 days of notice of the claim or legal action and takes into account substantially all factors affecting the outcome of the claim; determining objectives for defending litigation of the claim, where the determining objectives step occurs within 90 days of notice of the claim or legal action and where the objectives are aligned with business goals and sufficiently well-defined to be measured; developing a litigation plan and budget for defending litigation of the claim, where the developing step occurs within 90 days of notice of the claim or legal action and where the litigation plan and budget are consistent with determined objectives; defending the claim consistent with the determined objectives and the plan and budget; and upon resolution of a specific claim, recording all learnings from application of this method to the specific claim to form a database accessible by future teams.

### COPYRIGHT NOTICE AND AUTHORIZATION

This patent document contains material which is subject to copyright protection.

©Copyright 2005. ChevronTexaco Corporation. All rights reserved.

With respect to this material which is subject to copyright protection. The owner, ChevronTexaco Corporation, has no objection to the facsimile reproduction by any one of the patent disclosure, as it appears in the Patent and Trademark Office patent files or records of any country, but otherwise reserves all rights whatsoever.

### FIELD OF THE INVENTION

This invention relates to system and method for litigation risk management.

### BACKGROUND OF THE INVENTION

Over the last several years litigation against corporations has continued to increase. This litigation creates major potential financial liability exposure and requires corporations to gather and manage tremendous volumes of detailed information. In-house attorneys must manage a larger numbers of legal matters. It is difficult to coordinate the strategy for handling of these legal matters with all concerned parties. These may include business personnel, technology, legal, human resources, accounting and finance personnel.

Existing methods of managing corporate litigation and information technologies products aimed at the legal market have not satisfactorily addressed these problems. Thus, there is a need for a comprehensive methodology for developing a strategy consistent with business goals, coordinating and communicating on the matter with all concerned personnel, and capturing learnings from each matter handled over the entire lifecycle of all corporate legal matters.

A litigation risk management method is needed ensure business owners (i.e., individuals with profit and loss responsibility for the litigation) and employees are fully engaged and are effectively partnering with company attorneys and retained counsel to achieve well-defined litigation objectives through consistent litigation planning and execution. A method is needed which will systematically manage a company's litigation to vindicate the company's legal rights—promptly addressing legitimate liabilities, but vigorously defending against unfounded claims and demands; to optimize use of company resources and assets; to standardize best practices and process improvements; and to ensure that business and legal learnings are shared as appropriate. The instant invention provides such a solution.

### SUMMARY OF THE INVENTION

It is an object of this invention: (i) to have an integrated process suitable for use within a corporate legal department and providing for improved handling of a large volume of legal claims or lawsuits; (ii) to preserve evidence quickly after the claim is identified; (iii) to manage the claim jointly by a team able to represent the legal and business objectives; (iv) to closely coordinate claim processing with business objectives; and (v) to preserve knowledge of best practices developed over time in using the process of this invention and make it available to other users of the process.

Accordingly, the invention in one embodiment is a method for corporate litigation risk management for managing claims and legal actions including: forming a team including a managing attorney, a business owner, and an outside counsel for managing the claim or legal action, where the team forming step occurs within three days of notice of the claim or legal action; preserving documents, witnesses, and recollections related to the claim, where the preserving step preferably occurs within ten days of notice of the claim or legal action, and where attorney-client privilege is established for all communications during the preserving step; evaluating the claim with a litigation risk analysis, where the evaluating step preferably occurs within 90 days of notice of the claim or legal action and takes into account substantially all factors affecting the outcome of the claim; determining objectives for defending litigation of the claim, where the determining objectives step preferably occurs within 90 days of notice of the claim or legal action and where the objectives are aligned with business goals and sufficiently well-defined to be measured; developing a litigation plan and budget for defending litigation of the claim, where the developing step preferably occurs within 90 days of notice of the claim or legal action and where the litigation plan and budget are consistent with the determined objectives; defending the claim consistent with the determined objectives and the plan and budget; and upon resolution of a specific claim, recording all learnings from application of this method to the specific claim to form a database accessible by future teams.

In another embodiment of the invention, it includes a method for corporate litigation risk management for managing claims and legal actions including: forming a team including a managing attorney, a business owner, and an outside counsel for managing the claim or legal action, where the team forming step occurs within three days of notice of the claim or legal action; communicating within the team via a computer network; preserving documents, witnesses, and recollections related to the claim by storing them in a computer database and where attorney-client privilege is established for all communications during the preserving step; evaluating the claim with a litigation risk analysis, where the evaluating step occurs within 90 days of notice of the claim or legal action and takes into account substantially all factors affecting the outcome of the claim, and further includes imputing into a decision tree computer program sufficient data about the claim for the decision tree computer program to create a binary tree structure where each branch in the tree structure represents the likelihood of a court ruling and where each leaf node of the decision tree represents the probability of an award and amount of award following all paths from the root of the decision/binary tree to each leaf node of the decision/binary tree; determining objectives for defending litigation of the claim, where the determining objectives step occurs within 90 days of notice of the claim or legal action and where the objectives are aligned with business goals and sufficiently well-defined to be measured; developing a litigation plan and budget for defending litigation of the claim, where the developing step occurs within 90 days of notice of the claim or legal action and where the litigation plan and budget are consistent with determined objectives; defending the claim consistent with the determined objectives and the plan and budget; and upon resolution of a specific claim, recording all learnings from application of this method to the specific claim to form a computer searchable database accessible by future teams.

In another embodiment of the invention, it includes a system for corporate litigation claim/risk management for managing claims and legal actions including: a computer network configured and adapted for, within three days of notice of the claim or legal action, communication between a team including a managing attorney, a business owner, and an outside counsel for managing the claim or legal action; a first computer database configured and adapted for storing documents, witnesses, and recollections related to the claim and, optionally, for establishing attorney-client privilege for all communications related to stored documents, witnesses, and recollections; a decision tree computer code segment configured and adapted for evaluating the claim with a litigation risk analysis within 90 days of notice of the claim or legal action and for taking into account substantially all factors affecting the outcome of the claim, and for receiving input of a sufficient data about the claim for the decision tree computer program to create a binary tree structure where each branch in the tree structure represents the likelihood of a court ruling and where each leaf node of the decision/binary tree represents the probability of an award and amount of award following all paths from root to each leaf node of the decision tree; a second computer database configured and adapted for storing objectives for defending litigation of the claim, where the objectives are determined and stored in the second computer database within 90 days of notice of the claim or legal action and where the objectives are aligned with business goals and sufficiently well-defined to be measured; a third computer database configured and adapted for storing a litigation plan and budget for defending litigation of the claim within 90 days of notice of the claim or legal action and where the litigation plan and budget are consistent with objectives stored in the second computer database; a tracking computer code segment configured and adapted for storing and tracking data relevant to whether the claim is processed consistent with the objectives stored in the second computer database and the plan and budget stored in the third computer database; and a fourth computer database configured and adapted for, upon resolution of a specific claim, storing all learnings from processing of the specific claim and accessible by future teams.

These and other features and advantages of the present invention will be made more apparent through a consideration of the following detailed description of a preferred embodiment of the invention. In the course of this description, frequent reference will be made to the attached drawings.

### BRIEF DESCRIPTION OF THE DRAWINGS

FIG. 1 is a combination schematic block system diagram and data flow diagram of one embodiment of the invention.

FIG. 2 is an alternate view of a combination schematic block system diagram and data flow diagram of one embodiment of the invention.

FIG. 3 is a schematic block system diagram of one embodiment of the invention.

FIG. 4 is a schematic block context diagram of one embodiment of the invention.

FIG. 5 is a schematic block use-case diagram of one embodiment of the invention.

### DETAILED DESCRIPTION OF PREFERRED EMBODIMENTS

A. Introduction

The following discussion and figures include a general description of a suitable computing environment in which the invention may be implemented. While the invention will be described in the general context of an application program that runs on an operating system in conjunction with a personal computer, those skilled in the art will recognize that the invention also may be implemented in combination with other program modules. Generally, program modules include routines, programs, components, data structures, etc. that performs particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices. Reference to individual databases, e.g., first computer database and second computer database may either mean physical or logical computer databases or data structures. Multiple logical computer databases may be housed in a single physical database. Multiple data structures may be housed in a single logical and/or physical computer database.

The invention generally relates to a litigation risk management process and system and method (also referenced as “litigation claim management” process or system). Basic components of a computer-implemented embodiment of such a management system include: all of the software which will create, update, and manage the system, storage devices, processing devices, input/output devices, and network devices and software.

B. Method and System

Referring now to the drawings, in which like numerals represent like elements throughout the several figures, aspects of the present invention and a suitable operating environment will be described.

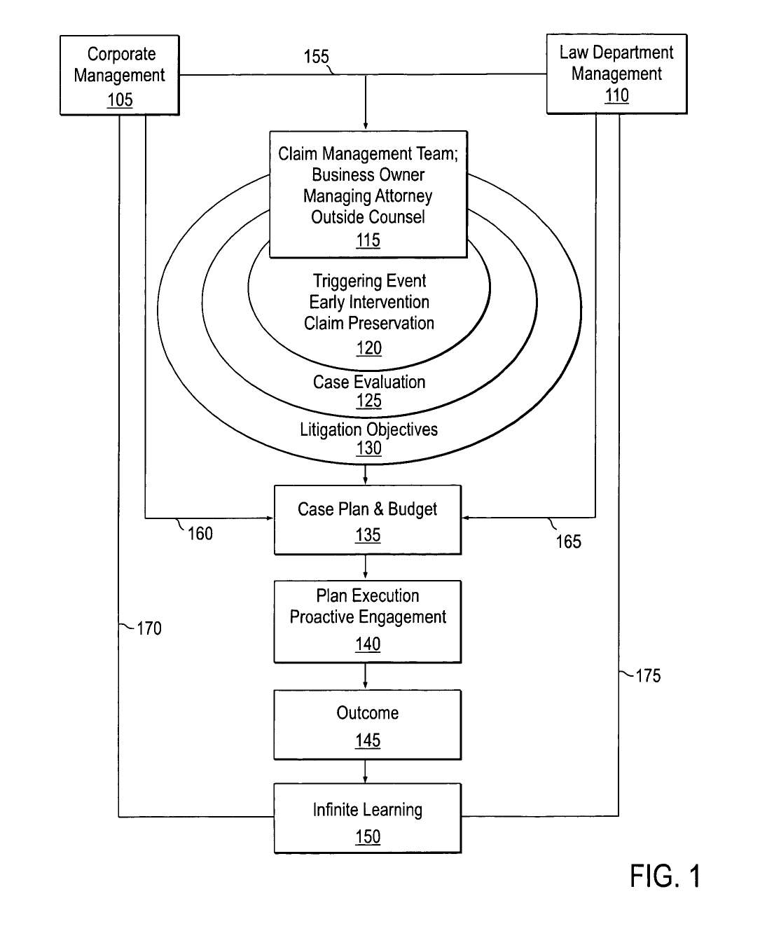

FIG. 1 is a combination schematic block system diagram and data flow diagram of one embodiment of the invention. A Triggering Event 120 is the first indication of a legal claim or controversy. Upon first learning of a Triggering Event 120 employees contact a company attorney. Upon notification of a Triggering Event 120, Corporate Management 105 and Law Department Management 110 cooperate to select a Claim Management Team 115 for each legal claim or lawsuit (jointly referenced as “claim” or “legal claim” or “case”). The Claim Management Team 115 will cooperate on all aspects of claim management.

Shortly after occurrence of the Triggering Event 120, preferable not more that about ten days, Claim Management Team 115 causes early intervention and claim preservation. The key aspects of early intervention are that employees seek legal counsel at the first indication of a legal claim or controversy, and engage the Business Owner and Managing Attorney in implementing the legal claim management process of the invention. The key goals of claim preservation are to identify, collect, and interview as appropriate relevant documents, witnesses, and testimony sufficient to preserve the company's rights and defenses relevant to the claim. Attorney-Client privilege is established for all related communications.

Following formation of the Claim Management Team 115, the Case Evaluation occurs in step 125. Preferably, a preliminary case evaluation occurs within ten days of the Triggering Event 120 and a comprehensive case evaluation occurs within 90 days. In the optional preliminary case evaluation the case is categorized based on the amount in controversy, including monetary exposure, costs, potential impact on the workforce, and risk to reputation and operations. Various case categorization approaches are possible, e.g., assigning a category from 1 to 4 where 1 is a minor claim and 4 is a major claim.

In the comprehensive case evaluation aspect of step 120 a comprehensive case evaluation and risk analysis is completed based on the best information available at that time. The case evaluations/analysis will address at least a portion of the factors, preferably substantially all factors, which could influence the outcome of the claim and preferably be based on reasoning processes that are transparent, logical, and fully understood by, and acceptable to, the Business Owner. The rigor and level of other company management participation at this stage will vary depending on the nature of the claim. Optionally, the case evaluation and risk analysis will be revised and updated as additional facts are discovered and/or events occur.

Determining Litigation Objectives step 130 follows Case Evaluation step 125. The Corporate Management 105, Law Department Management 110, Claim Management Team 115, or optionally only the Claim Management Team 115 or other subset or superset of persons (individually or collectively also referenced as “Stakeholders” or “Principal Stakeholders”), will cooperatively determine well-defined litigation objectives and the optimal strategy for obtaining them. Litigation objectives most preferably are specific and fully aligned with business imperatives. Case Plan and Budget step 135 follows Determining Litigation Objectives step 130. The principal Stakeholders will develop a case plan built around the specific litigation objectives determined in Litigation Objectives step 130. The case plan is preferably configured so that it represents the best strategic and tactical thinking, incorporates reasonable targets and milestones, takes due account of the risk assessment/case evaluation, including the company's image and reputation, and provides adequate resources to achieve the litigation objectives. The case plan undergoes regular review, as appropriate, to ensure continuous progress toward the litigation objectives from Litigation Objectives step 130.

Plan Execution step 140 follows Case Plan and Budget step 135. The case plan should preferably be executed aggressively in pursuit of the litigation objectives from Litigation Objectives step 130. The plan is preferably executed with the energy, focus and purpose necessary to fully vindicate the company's legal rights (also referred to as aggressive “proactive engagement”). Targets and milestones are measured against the case plan from step 135 to identify process gaps, assess performance, and determine next steps—the entire process is repeated as needed to assimilate new information.

Outcome step 145 follows Plan Execution step 140. The outcome can be a variety of events. Outcomes from legal claims include out of court settlement, settlement through voluntary or mandatory alternative dispute resolution, a binding decision of an arbitrator or panel of arbitrators, a final judgment from the trial court or appellate court, or mixtures of these.

Infinite Learning step 150 follows Outcome step 145. Infinite Learning is also referred to as knowledge management. It involves capturing and disseminating lessons learned from handling of a particular claim, storing and/or applying that knowledge to the process of the invention to further enhance its effectiveness and ease of use in handling later claims. Its benefits include standardizing best practices across a company/enterprise, promoting claim preservation and ensuring optimal performance in future litigation. Infinite Learning also contemplates that business lessons will be captured and shared as appropriate to improve a company's future legal position.

In particular, the Infinite Learning step preferably includes one or more or all of the following: (1) the Managing Attorney will obtain feedback from all Stakeholders after each significant case event or milestone and identify opportunities for leveraging and standardization, training, risk reduction in business operations, process improvements and enhanced cooperation; (2) a litigation management board (defined below) or other supervisory group will evaluate the feedback and communicate improvement opportunities to Business Owners and senior company management, ensure the Litigation Claim Management Process and an optional company intranet and/or extranet website for the process remain viable, and standardize best practices enterprise-wide; and (3) the litigation management board or other supervisory group will plan and conduct periodic litigation management forums with the Principal Stakeholders to discuss process improvements, best practices and training opportunities; (4) any combination thereof. All personnel responsible for a company's litigation and significant claims should be accountable for fulfilling their roles and responsibilities under this process. A litigation management board preferably includes lawyers and legal managers experienced in litigation from several practice areas or product areas within a company's legal department.

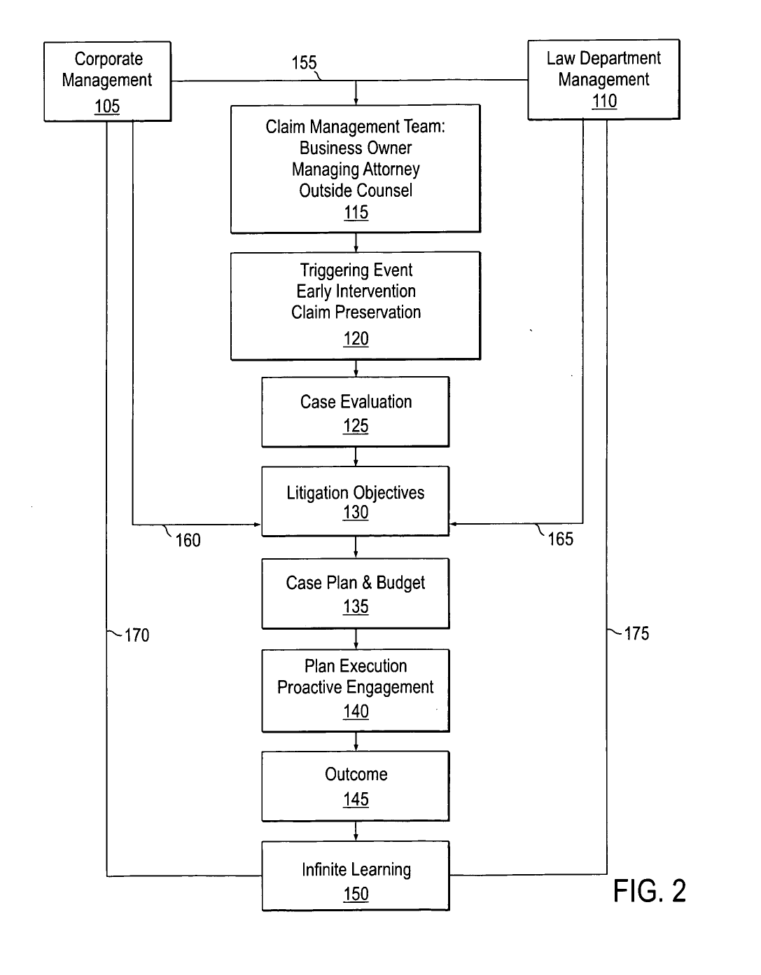

FIG. 2 is an alternate view of a combination schematic block system diagram and data flow diagram of one embodiment of the invention. Trigger Event step 120, Case Evaluation step 125, and determine Litigation Objectives step 130 are redrawn as successive steps where the succeeding step only occurs upon completion of the preceding step.

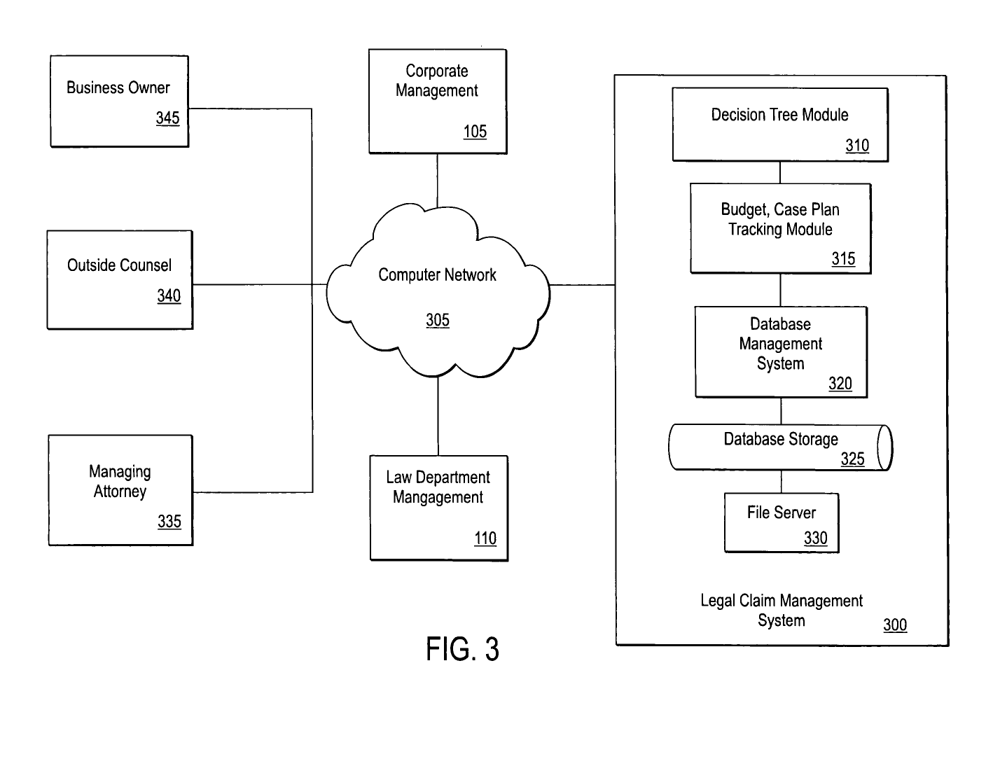

FIG. 3 is a schematic block system diagram of one embodiment of the invention. Each entity involved in the method, in one embodiment, is depicted. The various components and participants using the system are interconnected via Computer Network 305. Managing Attorney 335, Outside Counsel 340, Business Owner 345, Corporate Management 105, Law Department Management 110, and optionally others (not shown) are exemplary users of the system and are depicted as hosts operable connected to Computer Network 305. Each host optionally resides on a local area network operably connected via a gateway or other well known network device (not shown) to Computer Network 305. Communication over Computer Network 305 occurs via any conventional means such as via email clients (not shown) and mail servers (not shown).

Legal Claim Management System 300 is connected to Computer Network 305. It optionally contains components which include Database Management System 320, Database Storage 325, File Server 330, Budget and Case Tracking Module 315, and Decision Tree Module 310. Computer Network 305 is optionally the Internet or other public or private networks or combinations thereof. The communication of all entities through a common Computer Network 305 is illustrative only, and the invention includes embodiments where some entities communicate through one network, other entities through a different network, and various permutations thereof. That is, the Legal Claim Management System 300, as well as any general-purpose computers utilized by users and other entities (collectively, the “nodes”) preferably transmit digitally encoded data and other information between one another.

The communication links between the nodes preferably comprise a cable, fiber or wireless link on which electronic signals can propagate. For example, each node may be connected via an Internet connection using a public switched telephone network (PSTN), such as those provided by a local or regional telephone operating company. Alternatively, each node may be connected by dedicated data lines, cellular, Personal Communication Systems (“PCS”), microwave, or satellite networks.

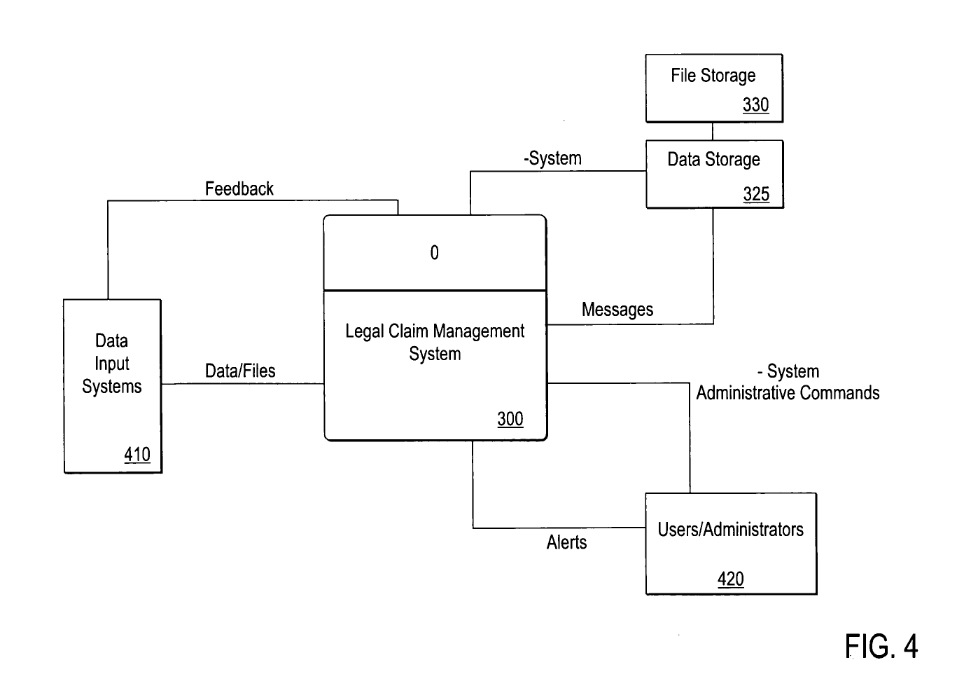

FIG. 4 is a schematic block context diagram of one embodiment of the invention. Entities interacting with Legal Claim Management System 300 include Data Input Systems 410, Users/Administrators 420, and Data/File Storage 325/330. Other entities not shown are contemplated within the scope of the invention. Users/Administrators 420 includes Managing Attorney 335, Outside Counsel 340, Business Owner 345, Corporate Management 105, Law Department Management 110 as depicted in FIG. 3.

Users/administrators 420 both pass and request data and files from Legal Claim Management System 300 and receive data and files as well as optionally reports and alerts. Data Input Systems 410 may include some users/administrators 420, e.g., where data is keyed in, but also may include automated data entry systems such as optical scanners, data or files received over Computer Network 305, e.g., from a court, other governmental agency, or from automatically generated or collected data from other information systems. Legal Claim Management System 300 stores data and files in data/file store 325/330. In addition to steps in the process of the invention described above, additional or implicit steps in using the system may include inputting data, searching data, and running reports. These are only exemplary steps and the invention contemplates other related steps including, but not limited to, creating, deleting, and updating data, alarms, automated reports, and interactive user-access. A user may log on, e.g., using a typical personal computer system or workstation system. Conventional or other types of security and/or user-access rights management are typically and optionally included.

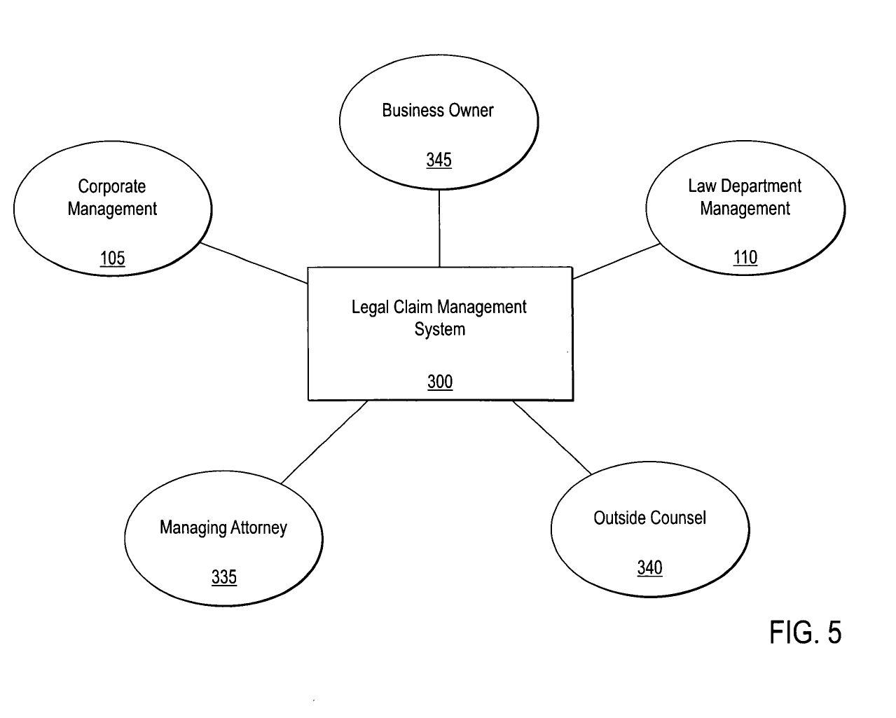

FIG. 5 is a schematic block use-case diagram of one embodiment of the invention. That is, it depicts in one embodiment exemplary users interacting with Litigation Risk Management System 300. These include, but are not limited to, Managing Attorney 335, Outside Counsel 340, Business Owner 345, Corporate Management 105, Law Department Management 110.

The Business Owner 345 is preferably the business person with profit or loss responsibility for the lawsuit. However, due to mergers, divestitures, portfolio changes, and reorganizations, some Business Owners 345 will own and be responsible for litigation outside of their current operational responsibilities. The Business Owner 345 has accountability, and is responsible for adopting and cascading the tenets of Litigation Claim Management Process/System 300 as necessary to ensure full alignment and support. The Business Owner 345 is also responsible for endorsing the litigation objectives, case plan and budget; ensuring the case plan is aligned with business imperatives; ensuring that appropriate resources are dedicated to the litigation effort, including his or her time; and providing higher management with timely status reports.

The Managing Attorney 335 is the link between the Business Owner 345, other business personnel, if any, and Outside Counsel 340, and is responsible for ensuring the effective flow of information. The responsibilities of the Managing Attorney 335 also include implementing Litigation Risk Management Process 300 and ensuring that litigation is conducted accordingly; ensuring that all relevant data (e.g., documents, email, witness recollections) are preserved; assisting Outside Counsel 340 with obtaining access to Company personnel, data and resources; monitoring execution of the case plan to ensure constant progress towards a company's litigation objectives; ensuring continuous alignment between business and litigation objectives; supporting the Business Owner's communications with higher management; and obtaining feedback from all Stakeholders after each significant case event or milestone for cases in the more major categories.

The Outside Counsel 340 is experienced counsel with extensive trial or other appropriate expertise, and is responsible for proactively and aggressively executing the case plan in a manner that reflects continuous alignment with a company's litigation objectives and the sound application of professional judgment.

The method/process aspect of the invention is illustrated and described in the figures and this written description as a series of process steps. As would be clear to one skilled in the art, one or more aspects/portions of the process steps can be embodied as code for a computer program for operation on a conventional programmed digital computer having, e.g., a client server or 3 tier architecture. The program code can be embodied as a computer program on a computer-readable storage medium or as a computer data signal in a carrier wave transmitted over Computer Network 305 (shown in FIG. 3).

A typical personal computer or workstation a user might log on with would include typical components such as a bus for communicating information, and a processor coupled with the bus for processing information, random access memory, coupled to the bus for storing information and instructions to be executed by the processor. Random Access Memory also may be used for storing temporary variables or other intermediate information during execution of instructions by the processor, a read only memory coupled to the bus for storing static information and instructions for the processor, and a data storage device coupled to the bus for storing information and instructions. The data storage device may include a magnetic disk or optical disk and its corresponding disk drive can be coupled to the computer system. Also the system may be coupled via the bus to a display device, such as a cathode ray tube, for displaying information to a computer user. The computer system further includes a keyboard and a cursor control, such as a mouse. Any other access devices for accessing a network are intended to be included in the invention. Such devices may include properly equipped and configured cellular phones and personal digital assistants.

While the preferred network is the Internet, other networks may be used, preferably capable of transmitting using any Network Protocol. The communication links between the entities for implementing the network preferably comprises a cable, fiber or wireless link on which electronic signals can propagate. For example, each entity may be connected via an Internet connection using a public switched telephone network such as those provided by a local or regional telephone operating company. Alternatively, each entity may be connected by dedicated data lines, cellular, Personal Communication Systems, microwave, or satellite networks.

C. Other Implementation Details

To the extent any embodiments of the system and method of the invention are computer-implemented; the following provides further description of this system and method:

1. Terms

The detailed description contained herein is represented partly in terms of processes and symbolic representations of operations by a conventional computer. The processes and operations performed by the computer include the manipulation of signals by a processor and the maintenance of these signals within data packets and data structures resident in one or more media within memory storage devices. Generally, a “data structure” is an organizational scheme applied to data or an object so that specific operations can be performed upon that data or modules of data so that specific relationships are established between organized parts of the data structure. For the purposes of this discussion, a process is generally conceived to be a sequence of computer-executed steps leading to a desired result. These steps generally require physical manipulations of physical quantities. Usually, though not necessarily, these quantities take the form of electrical, magnetic, or optical signals capable of being stored, transferred, combined, compared, or otherwise manipulated. It is conventional for those skilled in the art to refer to representations of these signals as bits, bytes, words, information, data, packets, nodes, numbers, points, entries, objects, images, files or the like. It should be kept in mind, however, that these and similar terms are associated with appropriate physical quantities for computer operations, and that these terms are merely conventional labels applied to physical quantities that exist within and during operation of the computer.

It should be understood that manipulations within the computer are often referred to in terms such as issuing, sending, altering, adding, disabling, determining, comparing, reporting, and the like, which are often associated with manual operations performed by a human operator. The operations described herein are machine operations performed in conjunction with various inputs provided by a human operator or user that interacts with the computer.

2. Hardware

It should be understood that the programs, processes, methods, etc. described herein are not related or limited to any particular computer or apparatus, nor are they related or limited to any particular communication architecture. Rather, various types of general purpose machines may be used with program modules constructed in accordance with the teachings described herein. Similarly, it may prove advantageous to construct a specialized apparatus to perform the method steps described herein by way of dedicated computer systems in specific network architecture with hard-wired logic or programs stored in nonvolatile memory, such as read only memory.

3. Program

In the preferred embodiment, the steps of the present invention are embodied in machine-executable instructions. The instructions can be used to cause a general-purpose or special-purpose processor which is programmed with the instructions to perform the steps of the present invention. Alternatively, the steps of the present invention might be performed by specific hardware components that contain hardwired logic for performing the steps, or by any combination of programmed computer components and custom hardware components.

The foregoing system may be conveniently implemented in a program or program module(s) that is based upon the diagrams and descriptions in this specification. No particular programming language has been required for carrying out the various procedures described above because it is considered that the operations, steps, and procedures described above and illustrated in the accompanying drawings are sufficiently disclosed to permit one of ordinary skill in the art to practice the present invention.

Moreover, there are many computers, computer languages, and operating systems which may be used in practicing the present invention and therefore no detailed computer program could be provided which would be applicable to all of these many different systems. Each user of a particular computer will be aware of the language and tools which are most useful for that user's needs and purposes.

The invention thus can be implemented by programmers of ordinary skill in the art without undue experimentation after understanding the description herein.

4. Components

The major components (also interchangeably called aspects, subsystems, modules, functions, services) of the system and method of the invention, and examples of advantages they provide, are described herein with reference to the figures. For figures including process/means blocks, each block, separately or in combination, is alternatively computer implemented, computer assisted, and/or human implemented. Computer implementation optionally includes one or more conventional general purpose computers having a processor, memory, storage, input devices, output devices and/or conventional networking devices, protocols, and/or conventional client-server hardware and software. Where any block or combination of blocks is computer implemented, it is done optionally by conventional means, whereby one skilled in the art of computer implementation could utilize conventional algorithms, components, and devices to implement the requirements and design of the invention provided herein. However, the invention also includes any new, unconventional implementation means.

5. Web Design

Any web site aspects/implementations of the system include conventional web site development considerations known to experienced web site developers. Such considerations include content, content clearing, presentation of content, architecture, database linking, external web site linking, number of pages, overall size and storage requirements, maintainability, access speed, use of graphics, choice of metatags to facilitate hits, privacy considerations, and disclaimers.

6. Other Implementations

Other embodiments of the present invention and its individual components will become readily apparent to those skilled in the art from the foregoing detailed description. As will be realized, the invention is capable of other and different embodiments, and its several details are capable of modifications in various obvious respects, all without departing from the spirit and the scope of the present invention. Accordingly, the drawings and detailed description are to be regarded as illustrative in nature and not as restrictive. It is therefore not intended that the invention be limited except as indicated by the appended claims.

What is claimed is:

1. A method for corporate litigation risk management for managing claims and legal actions comprising:
(a) forming a team comprising a managing attorney, a business owner, and an outside counsel for managing the claim or legal action;
(b) preserving documents, witnesses, and recollections related to the claim and wherein attorney-client privilege is established for all communications during the preserving step;
(c) evaluating the claim with a litigation risk analysis, taking into account substantially all factors affecting the outcome of the claim;
(d) determining objectives for defending litigation of the claim, wherein the objectives are aligned with business goals and sufficiently well-defined to be measured;
(e) developing a litigation plan and budget for defending litigation of the claim and wherein the litigation plan and budget are consistent with objectives determined in step (d);
(f) defending the claim consistent with the objectives determined in step (d) and the plan and budget developed in step (e); and
(g) upon resolution of a claim, recording all learnings from application of this method to the claim to form a database accessible by future teams formed per step (a).

2. The method of claim 1, wherein the team forming step occurs within three days of notice of the claim or legal action.

3. The method of claim 1, wherein the preserving step occurs within ten days of notice of the claim or legal action.

4. The method of claim 1, wherein the determining objectives step occurs within 90 days of notice of the claim or legal action.

5. The method of claim 1, wherein the evaluating step occurs within 90 days of notice of the claim or legal action.

6. The method of claim 1, wherein the developing step occurs within 90 days of notice of the claim or legal action.

7. The method of claim 1, wherein the preserving step (b) further comprises loading at least a portion of the documents, witnesses, and recollections related to the claim into a computer database.

8. The method of claim 1, wherein the evaluating step (c) further comprises imputing into a decision tree computer program sufficient data about the claim for the decision tree computer program to create a binary tree structure wherein each branch in the tree structure represents the likelihood of a court ruling and wherein each leaf node of the decision tree represents the probability of an award and amount of award following all paths from the root of the binary tree to each leaf node of the binary tree.

9. The method of claim 8, wherein the data input into the decision tree computer program comprises the elements of the claim or legal action cause of action in issue, probabilities of those elements being found by the court to have been met, the amount of damages in dispute, and mixtures thereof.

10. The method of claim 1, wherein the database in recording step (g) is configured and adapted as a computer searchable database.

11. The method of claim 10, wherein the computer searchable database comprises a plurality of data structures stored in a relational database.

12. The method of claim 10, wherein the computer searchable database is accessible via a web browser-based graphical user interface.

13. The method of claim 1, further comprising communicating within the team formed in step (a) via a computer network.

14. The method of claim 13, wherein the communication utilizes the Transmission Control Protocol and the Internet Protocol.

15. The method of claim 13, wherein the computer network comprises the Internet.

16. The method of claim 13, wherein the communication utilizes a web browser-based graphical user interface.

17. A method for corporate litigation risk management for managing claims and legal actions comprising:
(a) forming a team comprising a managing attorney, a business owner, and an outside counsel for managing the claim or legal action, wherein the team forming step occurs within three days of notice of the claim or legal action;
(b) communicating within the team formed in step (a) via a computer network.
(c) preserving documents, witnesses, and recollections related to the claim by storing them in a computer database, wherein the preserving step (c) occurs within ten days of notice of the claim or legal action and wherein attorney-client privilege is established for all communications during the preserving step;
(d) evaluating the claim with a litigation risk analysis, wherein the evaluating step occurs within 90 days of notice of the claim or legal action and takes into account substantially all factors affecting the outcome of the claim, and further comprises imputing into a decision tree computer program sufficient data about the claim for the decision tree computer program to create a binary tree structure wherein each branch in the tree structure represents the likelihood of a court ruling and wherein each leaf node of the decision tree represents the probability of an award and amount of award following all paths from the root of the binary tree to each leaf node of the binary tree;
(e) determining objectives for defending litigation of the claim, wherein the determining objectives step occurs within 90 days of notice of the claim or legal action and wherein the objectives are aligned with business goals and sufficiently well-defined to be measured;
(f) developing a litigation plan and budget for defending litigation of the claim, wherein the developing step occurs within 90 days of notice of the claim or legal action and wherein the litigation plan and budget are consistent with objectives determined in step (d);
(g) defending the claim consistent with the objectives determined in step (d) and the plan and budget developed in step (e); and
(h) upon resolution of a specific claim, recording all learnings from application of this method to the specific claim to form a computer searchable database accessible by future teams formed per step (a).

18. The method of claim 17, wherein the data input into the decision tree computer program in evaluating step (d) comprises the elements of the claim or legal action cause of action in issue, probabilities of those elements being found by the court to have been met, the amount of damages in dispute, and mixtures thereof.

19. The method of claim 17, wherein the computer searchable database comprises a plurality of data structures stored in a relational database.

20. The method of claim 17, wherein the computer searchable database is accessible via a web browser-based graphical user interface.

21. The method of claim 17, wherein the communication utilizes the Transmission Control Protocol and the Internet Protocol.

22. The method of claim 17, wherein the computer network comprises the Internet.

23. The method of claim 17, the communication utilizes a web browser-based graphical user interface.

24. A system for corporate litigation risk management for managing claims and legal actions comprising:
(a) a computer network configured and adapted for communication within three days of notice of the claim or legal action between a team comprising a managing attorney, a business owner, and an outside counsel for managing a claim or legal action;
(b) a first computer database configured and adapted for storing documents, witnesses, and recollections related to the claim and establishing attorney-client privilege for all communications relating to the storing of the documents, witnesses, and recollections;
(c) a decision tree computer code segment configured and adapted for evaluating the claim with a litigation risk analysis and for evaluating within 90 days of notice of the claim or legal action and for taking into account substantially all factors affecting the outcome of the claim, and for receiving impute of a sufficient data about the claim to create a binary tree structure wherein each branch in the tree structure represents the likelihood of a court ruling and wherein each leaf node of the decision tree represents the probability of an award and amount of award following all paths from the root of the binary tree to each leaf node of the binary tree;
(d) a second computer database configured and adapted for storing objectives for defending litigation of the claim within 90 days of notice of the claim or legal action and wherein the objectives are aligned with business goals and sufficiently well-defined to be measured;
(e) a third computer database configured and adapted for storing litigation plan and budget for defending litigation of the claim within 90 days of notice of the claim or legal action and wherein the litigation plan and budget are consistent with objectives stored in the second computer database;
(f) a tracking computer code segment configured and adapted for storing and tracking data relevant to whether the claim is processed consistent with the objectives stored in the second computer database and the plan and budget third computer database; and
(g) a fourth computer database configured and adapted for, upon resolution of a specific claim, storing all learnings from processing of the specific claim and accessible by future teams.

25. The system of claim 24, wherein the first computer database is further configured and adapted for being populated with the documents, witnesses, and recollections related to the claim within ten days of notice of the claim or legal action.

26. The system of claim 24, wherein the decision tree computer code segment is further configured and adapted for receiving data input comprising the elements of the claim or legal action cause of action in issue, probabilities of those elements being found by the court to have been met, the amount of damages in dispute, and mixtures thereof.

27. The system of claim 24, wherein each computer database comprises a plurality of data structures stored in a relational database.

28. The system of claim 24, wherein each computer database is in operably connected with a web browser-based graphical user interface.

29. The system of claim 24, wherein the computer network utilizes the Transmission Control Protocol and the Internet Protocol.

30. The system of claim 24, wherein the computer network comprises the Internet.

31. The system of claim 24, the computer network is operably connected with a web browser-based graphical user interface.
